(19) United States
(12) Patent Application Publication
(10) Pub. No.: US 2008/0072989 A1
(43) Pub. Date: Mar. 27, 2008

(54) Squeeze resistant flange cover and method of making same

(76) Inventors: Jose A. Lepe, Corona, CA (US); Ricardo Alba, Los Angeles, CA (US)

Correspondence Address: BIRCH STEWART KOLASCH & BIRCH, PO BOX 747, FALLS CHURCH, VA, 22040-0747, US

(21) Appl. No.: 11/525,120

(22) Filed: Sep. 22, 2006

(51) Int. Cl. F16L 57/00

(52) U.S. Cl. 138/96 R; 138/89

(57) ABSTRACT

A flange cover comprised of an end cap portion and an annular sidewall portion, said sidewall portion being comprised of a flexible polymeric material, and said end cap portion being comprised of a polymeric material of lesser flexibility than said sidewall portion.

### BACKGROUND OF THE PRESENT INVENTION

The present invention relates generally to flange covers and to methods of making flange covers and other articles.

Flange covers, which have been produced by Caplus West of Rancho Dominguez, Calif., a company of Mark IV Industries, Inc., are caps of resilient material which are intended to be temporarily placed over end flanges of pipes or tubes of apparatus to prevent entrance of contaminating materials and damage during storage, transport or painting thereof. For example, in the airline industry, flange covers have been used to protect the open ends of fuel, air conditioning, and hydraulic lines. The flanges of the pipe ends are “snapped” into the resilient or flexible flange covers. Such flange covers have been constructed to fit as plugs into the open ends of tubes and pipes. Flange covers may also be provided to cap flangeless pipes or tubes and to similarly plug or cover other portions of apparatus. Thus, as used herein, the term “flange cover” is defined to include both caps and plugs and covers for pipes and tubes, whether flanged or unflanged, and other portions of apparatus.

It has been sometime experienced that after a flange cover is removed, it is squeezed into a port of the product being protected instead of being appropriately discarded, resulting in a potential product failure such as by the clogging of a fuel line.

### OBJECT AND SUMMARY OF THE INVENTION

It is accordingly an object of the present invention to provide a flange cover which provides a flexible fit yet is resistant to such squeezing into ports of apparatus.

In order to provide such a flange cover, in accordance with the present invention, the flange cover is formed as a single piece having a relatively hard or rigid dome portion (the generally flat portion which extends across an opening) and a relatively soft sidewall portion (the generally cylindrical portion which extends lengthwise of the wall of the tube or pipe being capped or plugged).

The combination of both hard and soft durometery provides improved impact resistance and protection from damage during handling. The soft durometer is typically the underlayer protecting the component surface. The higher durometer (harder layer) is typically the outer layer which provides additional protection to the protected component than what would be available in a single durometer flange cover.

The above and other objects, features, and advantages of the present invention will be apparent in the following detailed description of the preferred embodiments of the present invention when read in conjunction with the accompanying drawings wherein the same reference numerals denote the same or similar parts throughout the several views.

### BRIEF DESCRIPTION OF THE INVENTION

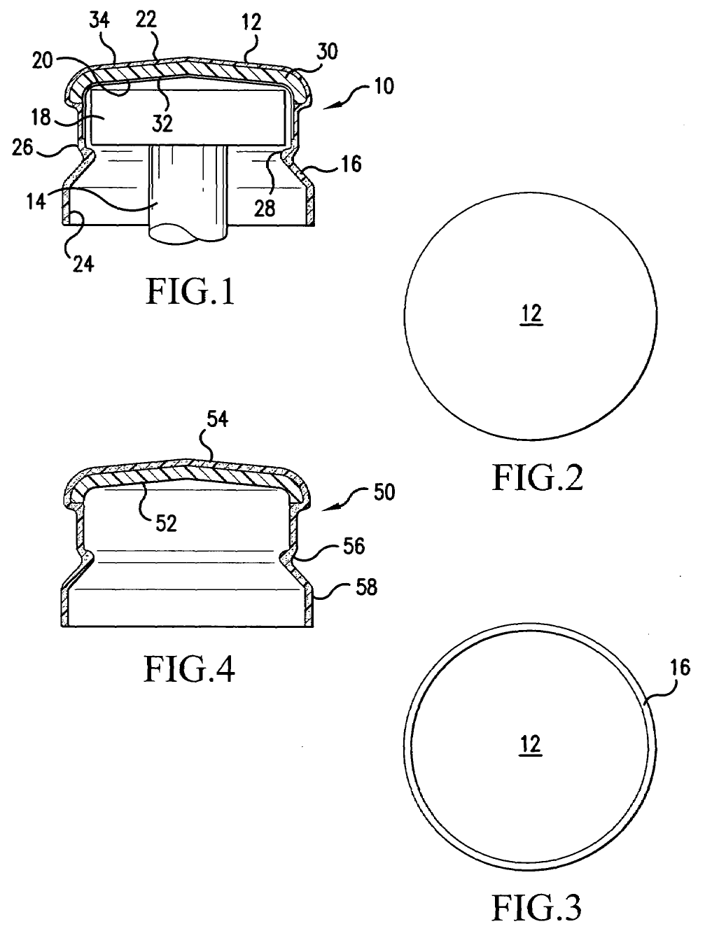

FIG. 1 is a sectional view of a flange cover which embodies the present invention, capping a flanged tube.

FIG. 2 is a top view thereof.

FIG. 3 is a bottom view thereof.

FIG. 4 is a view similar to that of FIG. 1 of an alternative embodiment thereof.

### DETAILED DESCRIPTION OF THE INVENTION

Referring to the Figures, there is shown generally at 10 a flange cover which includes a generally flat dome portion 12 (which extends across the end opening of tube 14) having an inner surface 20 and an outer surface 22 and further includes a generally cylindrical skirt or sidewall portion 16 (which extends lengthwise of the tube wall) having an inner surface 24 and an outer surface 26. The flange cover 10 may come in various sizes having a diameter in the range typically of 1 to 12 inches.

The tube 14 is shown to have an end flange 18. The flange cover sidewall portion 16 is shaped to have an annular ridge or reduced diameter portion 28 on its inner surface 24. The ridge portion 28 is spaced from the inner surface 20 of the dome portion 12 a distance which is greater than the width of flange 18 so that the flange 18 may be positioned as shown between the dome 12 and the ridge portion 28. The diameter of the ridge portion is less than that of the flange 18 and the sidewall portion 16 is sufficiently flexible, as discussed hereinafter, to allow the flange to be pushed between the ridge portion 28 and then be held or retained or trapped by the ridge portion 28 between the dome 12 and the ridge portion 28, to thereby effectively cap the tube 14. The outer surface 26 of the sidewall portion 16 is also shaped so that the flange cover 10 may alternatively be inserted in an opening as a plug.

Previously, flange covers have been made of a suitably resilient material to well achieve their purpose. However, as previously discussed, it has been experienced that sometimes after a flange cover is removed, its resiliency has allowed it to be inadvertantly squeezed into a port or bore of the product being protected instead of being appropriately discarded, resulting in a potential product failure.

In order to provide resistance to such squeezing, in accordance with the present invention, the flange cover 10 is formed, as discussed hereinafter, as a unitary section having a relatively hard or rigid dome portion 12 to provide the desired squeeze resistance and a relatively soft or resilient or flexible sidewall portion 16 to provide the desired flexibility in installation and removal of the flange portion.

By way of example, the flange cover 10 has a relatively hard or rigid portion 30 substantially forming the dome 12, a first relatively soft or flexible or pliable portion 32 underlying the rigid portion 30 and extending along the sidewall portion 16 and terminating short of the ridge 28 to protect the flange 18 from becoming scratched or abraded by rigid portion 30, and a second relatively soft or flexible or pliable portion 34 overlying the rigid portion 30 and forming the remainder of the sidewall portion 16.

For example, the rigid portion 30 will generally have a hardness in the range of 85 to 95 Shore A and a thickness in the range of 50 to 120 mils, and the relatively soft portion 32 may have a hardness in the range of 40 to 50 Shore A hardness, and a thickness in the range of 50 to 120 mils.

The flange may be formed by a conventional dip molding process. Liquid vinyl polymers are commonly employed in dip molding processes in the form of plastisols. The process of dip molding has been used commercially for decades to produce articles of various shapes and configurations. In a dip molding process, a heated mold form or mandrel is dipped into a plastisol bath whereupon a layer of fused plastisol forms about the mandrel. The coated mandrel is removed from the bath, and the coating layer cured, resulting in a molded article corresponding in configuration to the configuration of the mandrel which is employed. For instance, a cylindrical mandrel (or pin) is employed to produce a tubular article such as the product of the present invention.

In order to form the flange cover of the present invention, which is comprised of several layers, multiple dip molding steps are employed. It is desirable at times to control the thickness of the respective layers of plastisol that forms on the mandrel during the dip molding process. The thickness of the layer of fused plastisol that forms on the mandrel is related to the amount of heat transfer between the mandrel and the surrounding plastisol bath. As a result, metallic mandrels are employed which are preheated prior to being dipped into the plastisol bath. The thickness of the layer which forms on the mandrel depends on the initial temperature of the mandrel, and the amount of time that the mandrel is retained in the bath (both of which affect the amount of heat which is available to cause a layer of gelled plastisol to form on the exterior surface of the mandrel. Generally, the mandrel is heated to a temperature of from 350° F. to 600° F. by means such as being passed through an oven, placed in a heated liquid bath, heated by an internal heating element, etc. The particular method is not critical as long as the mandrel is heated to a temperature sufficiently high to cause the required fusion of the plastisol on the outer circumferential surface of the mandrel once the mandrel is placed into the plastisol bath. Generally, it has been found that the mandrel may remain in contact with the plastisol bath for a period of time ranging from several seconds to 3 minutes or so.

Once the mandrel contacts the plastisol bath for a period sufficient to form a gelled/fused layer of desired thickness, the coated mandrel is removed from the bath. The resulting thickness of the molded article generally ranges from about 0.03 to 0.20 inch. The coated mandrel is slowly removed from the plastisol bath to enable excess non-gelled/fused plastisol to fall from the mandrel. Next, the molded part may be dipped into a different material tank, whereupon a second (and/or subsequent) layer may be formed thereon.

The coated mandrel is then cured to solidify the gelled/fused layer on the mandrel. Such curing may occur by heating the coated mandrel in an oven at a temperature of from about 400 to 550° F. for a period of time ranging from about 0.50 to 8 minutes. Such curing steps are conventional and well know to those of ordinary skill in the art.

Once all desired layers are formed on the mandrel, the molded flange may be removed by air pressure or mechanical methods from the mandrel. The mandrel may then be resused.

As multiple layers of plastisol are desired, the dipping and curing steps will be repeated until the desired number of layers are formed. As it is desirable to have adjacent “soft” and “hard” layers in the resulting product, the respective composition of the various plastisols which are used will differ so as to provide plastisol layers having the requisite properties.

The composition of the plastisol bath is not critical, as a wide variety of plastisol compositions are conventionally employed. The plastisol (polyvinylchloride) bath may include various colorants (to cause formation of a molded flange of a particular color), as well as other conventional additives.

As multiple layers of the plastisol are desired, the dipping/curing steps will be repeated as many times as required. The formation of multiple plastisol layers is well known to those of ordinary skill in the art. See, for example, U.S. Pat. Nos. 3,904,720 and 4800,116, each herein incorporated by reference.

Two or more than three dippings to form a flange cover is meant to come within the scope of the present invention. Thus, referring to FIG. 4, there is shown generally at 50 a flange cover which has been dipped two times: a first dip of only the dome portion of the heated mandrel in a rigid vinyl plastisol to form a relatively rigid portion 52 in the dome 54, and a second dip of the heated mandrel in a flexible vinyl plastisol to form a relatively flexible portion 56 covering the rigid portion 52 and forming the sidewall portion 58.

In accordance with yet another embodiment, the heated mandrel is first dipped in a flexible vinyl plastisol to form a flexible portion, then the dome portion of the heated mandrel is dipped in a rigid vinyl plastisol to form a rigid dome portion overlying the flexible portion, whereby the flange of a capped pipe may be protected from scratching by the rigid dome portion.

The combination of both hard and soft durometery provides improved impact resistance and protection from damage during handling, with the soft durometer typically being the underlying protective layer and the hard durometer typically being the outer layer which provides additional protection to the protected component than what would be available in a single durometer flange cover.

It should be understood that, while the present invention has been described in detail herein, the invention can be embodied otherwise without departing from the principles thereof, and such other embodiments are meant to come within the present invention as defined by the appended claims.

What is claimed is:

1. A flange cover comprised of an end cap portion and an annular sidewall portion, said sidewall portion being comprised of a flexible polymeric material, and said end cap portion being comprised of a polymeric material of lesser flexibility than said sidewall portion.

2. The flange cover of claim 1, wherein said end cap and sidewall portions are comprised of a vinyl material.

3. The flange cover of claim 1, wherein said sidewall portion includes an inner surface thereof an annular ridge portion which extends inwardly a distance from said inner surface.

4. The flange cover of claim 1, wherein said end cap portion is substantially flat.

5. The flange cover of claim 1, wherein said end cap is substantially rigid.

6. The flange cover of claim 1, wherein said sidewall portion includes an indent portion on an outer surface thereof corresponding to the annular ridge on said inner surface of sidewall portion.

7. The flange cover of claim 1, which is formed by multiple dip molding steps.

8. The flange cover of claim 1, wherein said portion of said end cap which has reduced flexiblity extends both laterally across the top of said flange cover and downwardly across a-portion of said sidewall portion.
